(19) United States
(12) Patent Application Publication
(10) Pub. No.: US 2017/0008408 A1
(43) Pub. Date: Jan. 12, 2017

(54) METHOD FOR CONTROLLING OUTPUT OF LOW VOLTAGE DC-DC CONVERTER IN VEHICLE AND LOW VOLTAGE DC-DC CONVERTER OF VEHICLE

(71) Applicants: Hyundai Motor Company, Seoul (KR); Kia Motors Corporation, Seoul (KR)

(72) Inventors: Jun Yeon Park, Yongin (KR); Dong Jun Shin, Hwaseong (KR); Sounghan Noh, Suwon (KR); Hojoong Lee, Anyang (KR); Dong Pil Yoon, Incheon (KR); Chang Ryeol Yoo, Incheon (KR)

(21) Appl. No.: 14/941,616

(22) Filed: Nov. 15, 2015

(30) Foreign Application Priority Data
Jul. 10, 2015 (KR) 10-2015-0098313

(51) Int. Cl. B60L 11/18

(52) U.S. Cl. CPC B60L 11/1814; B60L 11/1861; B60L 11/1805

(57) ABSTRACT

A method for controlling an output of an LDC converter of a vehicle is provided. The LDC charges and discharges an auxiliary battery supplying power to an electronic load using a high voltage battery for driving the vehicle. The method includes predicting a driving event of a front section of the vehicle based on driving route information and a SOC of the auxiliary battery in a driving event before the driving event of the front section of the vehicle. Output voltage of the low voltage DC-DC converter is converted and output to the electronic load or the auxiliary battery based on a comparison result between a current SOC of the auxiliary battery and the predicted SOC of the auxiliary battery. The predicted SOC is determined by a charge time of when a brake or accelerator pedal is engaged before the driving event of the front section of the vehicle.

### CROSS-REFERENCE TO RELATED APPLICATION

This application claims priority to and the benefit of Korean Patent Application No. 10-2015-0098313 filed in the Korean Intellectual Property Office on Jul. 10, 2015, the entire contents of which are incorporated herein by reference.

### BACKGROUND

(a) Field of the Invention

The present invention relates to a technology related to an environmentally friendly vehicle, and more particularly, to a method for controlling an output of a low voltage direct current-direct current (DC-DC) converter in an environmentally friendly vehicle and a low voltage DC-DC converter of an environmentally friendly vehicle.

(b) Description of the Related Art

In general, an electric vehicle (EV) and a hybrid electric vehicle (HEV) which are types of environmentally friendly vehicles are operated by force of a motor by a battery power supply. Since the environmentally friendly vehicle is moved even by the force of the motor, a high-voltage large-capacity battery (e.g., a main battery) and a low voltage DC-DC converter (LDC) that charges an auxiliary battery, such as an alternator converting voltage of the main battery into low voltage, are mounted on the environmentally friendly vehicle. Herein, the auxiliary battery generally means a vehicle battery configured to supply power for ignition and to various electrical devices of a vehicle.

Further, the LDC is configured to supply the power to vary the voltage of the main battery to be suitable for voltage used for an electric/electronic load of the vehicle. In general, the hybrid vehicle is a type of vehicle driven by efficiently combining two or more different power sources, but in most cases, the hybrid vehicle acquires drive force by an engine using a fuel and an electric motor driven by power of a battery, which is called a hybrid electric vehicle (HEV).

In recent years, research into the hybrid electric vehicle has been in active progress in response to the demand for enhancing fuel efficiency and developing a more environmentally friendly product. The hybrid electric vehicle may have various structures using the engine and the electric motor as the power sources, and as many vehicles that have been researched recently, one of a parallel type and a serial type has been used.

Particularly, in the parallel type, the engine charges the battery, but directly drives the vehicle together with the electric motor, and the parallel type has an disadvantage in that it is more complex in terms of a structure and in terms of a control logic. However, the parallel type is widely adopted in a vehicle due to an advantage of efficiently using energy due to mechanical energy of the engine and electrical energy of the battery may be used simultaneously.

Since optimal operating areas of the engine and the electric motor are used, fuel efficiency of the drive system is improved, and since the energy is recovered by the electric motor while braking, the energy may be used efficiently. In addition, a hybrid control unit (HCU) is installed in the hybrid vehicle, and each apparatus constituting the system includes a controller. For example, the system includes an engine control unit (ECU) configured to operate the engine, a motor control unit (MCU) configured to operate the electric motor, a transmission control unit (TCU) configured to operate a transmission, a battery management system (BMS) configured to monitor and manage a state of the battery, and a full auto temperature controller (FATC) configured to adjust a temperature in the vehicle.

Herein, the HCU is an uppermost controller configured to drive each of the controllers, set a hybrid operation mode, and operate the vehicle, and the respective controllers are connected via a controller area network (CAN) communication line based on the HCU which is the uppermost controller to allow the upper controller to transfer a command to a lower controller while the controllers transmit and receive information to and from each other.

Further, a high-voltage battery (e.g., main battery) configured to provide driving power of the electric motor is mounted on the hybrid vehicle, and the high-voltage battery is configured to supply required power while repeating charge or discharge while the vehicle is driven. In motor assist, the high-voltage battery supplies (e.g., discharges) the electric energy and stores (e.g., charges) the electric energy in regenerative braking or engine driving, and in this case, the BMS is configured to transmit a state of charge (SOC), available charged power, and available discharged power of the battery to the HCU and the MCU to perform battery safety and life-span management.

Further, an auxiliary battery (e.g., low-voltage battery) configured to provide driving power of an electric/electronic subassembly is installed in the hybrid vehicle together with the main battery (e.g., high-voltage battery) configured to provide the driving power of the electric motor (e.g., driving motor). The low voltage DC-DC converter (LDC) for output conversion between high voltage and low voltage is connected to the auxiliary battery.

The above information disclosed in this section is merely for enhancement of understanding of the background of the invention and therefore it may contain information that does not form the prior art that is already known in this country to a person of ordinary skill in the art.

### SUMMARY

The present invention provides a method for controlling an output of a low voltage DC-DC converter in an environmentally friendly vehicle, and a low voltage DC-DC converter of the environmentally friendly vehicle which adjusts output voltage of the low voltage DC-DC converter by more accurately predicting a charge time or a discharge time of an auxiliary battery by learning the time when a brake pedal or an accelerator pedal is engaged before a driving event such as an acceleration period event based on a propensity of the driver.

An exemplary embodiment of the present invention provides a method for controlling an output of a low voltage DC-DC converter (LDC) of an environmentally friendly vehicle, that may include: predicting, by an event determining unit mounted in the low voltage DC-DC converter charging or discharging an auxiliary battery supplying power to an electric/electronic load using a high voltage battery for driving the environmentally friendly vehicle, a driving event of a front section of the environmentally friendly vehicle based on driving route information; predicting, by a predicting unit of the low voltage DC-DC converter, a state of charge (SOC) of the auxiliary battery in a driving event before the driving event of the front section of the environmentally friendly vehicle; and converting, by a variable voltage outputting unit of the low voltage DC-DC converter, output voltage of the low voltage DC-DC converter and outputting the converted output voltage to the electric/electronic load or the auxiliary battery based on a comparison result between a current SOC of the auxiliary battery and a predicted SOC of the auxiliary battery.

In particular, the predicted SOC of the auxiliary battery may be determined by a charge time of the auxiliary battery based on a propensity at the time when a brake pedal is engaged before the driving event of the front section of the vehicle, or may be determined by a discharge time of the auxiliary battery based on a propensity when an accelerator pedal is engaged before the driving event of the front section of the vehicle.

The method may further include calculating, by the predicting unit of the low voltage DC-DC converter, the predicted SOC of the auxiliary battery based on a map table that includes the SOC of the auxiliary battery, which corresponds to the charge time or the discharge time of the auxiliary battery. The charge time of the auxiliary battery may correspond to a distance calculated using a brake signal indicating the amount of pressure exerted onto brake pedal, and the discharge time of the auxiliary battery may correspond to a distance calculated using an acceleration signal indicating the amount of pressure exerted onto the accelerator pedal.

The converting of the output voltage of the low voltage DC-DC converter and outputting the converted output voltage to the electric/electronic load or the auxiliary battery may include outputting, by the variable voltage outputting unit, a voltage to allow the voltage of the auxiliary battery to be discharged to the electric/electronic load when the current SOC of the auxiliary battery is less than the predicted SOC of the auxiliary battery. Additionally, the converting of the output voltage of the low voltage DC-DC converter and outputting the converted output voltage to the electric/electronic load or the auxiliary battery may include outputting, by the variable voltage outputting unit, a voltage that allows the auxiliary battery to be charged when the current SOC of the auxiliary battery is greater than the predicted SOC of the auxiliary battery.

The method may further include outputting, by the variable voltage outputting unit, a maximum value of the output voltage of the low voltage DC-DC converter to charge the auxiliary battery in response to a high voltage battery discharge control signal. The driving event may include acceleration section information of the vehicle, deceleration section information of the vehicle, and cruise section information of the vehicle. The current SOC of the auxiliary battery may be measured by an intelligent battery sensor. The driving route information may be provided by an audio video navigation (AVN) apparatus including three-dimensional (3D) road map information.

Another exemplary embodiment of the present invention provides a low voltage DC-DC converter (LDC) of a vehicle (e.g., an environmentally friendly vehicle), that may include: an event determining unit within the low voltage DC-DC converter charging or discharging an auxiliary battery configured to charge power to an electric/electronic load using a high voltage battery for driving the vehicle and configured to predict a driving event of the vehicle based on driving route information; a predicting unit of the low voltage DC-DC converter configured to predict a state of charge (SOC) of the auxiliary battery in a driving event before the driving event of a front section of the vehicle; and a variable voltage outputting unit of the low voltage DC-DC converter configured to convert output voltage of the low voltage DC-DC converter and output the converted output voltage to the electric/electronic load or the auxiliary battery based on a comparison result between a current SOC of the auxiliary battery and a predicted SOC of the auxiliary battery.

In particular, the predicted SOC of the auxiliary battery may be determined by a charge time of the auxiliary battery based on a propensity at the time when a brake pedal is engaged before the driving event of the front section of the vehicle, or may be determined by a discharge time of the auxiliary battery based on a propensity at the time when an accelerator pedal is engaged before the driving event of the front section of the vehicle.

The predicting unit may be configured to calculate the predicted SOC of the auxiliary battery based on a map table that includes the SOC of the auxiliary battery, which corresponds to the charge time or the discharge time of the auxiliary battery. The charge time of the auxiliary battery may be a value that corresponds to a distance calculated using a brake signal indicating the amount of pressure exerted onto brake pedal, and the discharge time of the auxiliary battery may be a value that corresponds to a distance calculated using an acceleration signal indicating the amount of pressure exerted accelerator pedal.

The variable voltage outputting unit may be configured to output a voltage to allow the voltage of the auxiliary battery to be discharged to the electric/electronic load when the current SOC of the auxiliary battery is less than the predicted SOC of the auxiliary battery. The variable voltage outputting unit may further be configured to output voltage that allows the auxiliary battery to be charged when the current SOC of the auxiliary battery is greater than the predicted SOC of the auxiliary battery. The variable voltage outputting unit may be configured to output a maximum value of the output voltage of the low voltage DC-DC converter to charge the auxiliary battery in response to a high voltage battery discharge control signal.

The driving event may include acceleration section information of the vehicle, deceleration section information of the vehicle, and cruise section information of the vehicle. The current SOC of the auxiliary battery may be measured by an intelligent battery sensor. The driving route information may be provided by an audio video navigation (AVN) apparatus including 3D road map information.

According to exemplary embodiments of the present invention, a method for controlling an output of a low voltage DC-DC converter in a vehicle, and a low voltage DC-DC converter of a vehicle, may improve fuel efficiency of a vehicle by maximizing charging efficiency or discharging efficiency of an auxiliary battery and may be applied to vehicles including a hybrid electric vehicle (HEV) and a plug-in hybrid electric vehicle (PHEV).

The fuel efficiency of the vehicle may be enhanced by reducing average power consumption of the low voltage DC-DC converter (LDC) by about 2.9% using a charge time or a discharge time of the auxiliary battery based on a propensity of a driver (e.g., tendency of engagement degree of a brake or accelerator pedal). Since variable voltage which is an output voltage of the LDC may be optimized by predicting a charge amount or a discharge amount of the auxiliary battery through predicting a front road section of the vehicle, the durability of the auxiliary battery may be improved.

### BRIEF DESCRIPTION OF THE DRAWINGS

A brief description of each drawing is provided to more sufficiently explain the drawings used in the detailed description of the present invention.

FIG. 1 is a block diagram illustrating a low voltage DC-DC converting system of a vehicle according to an exemplary embodiment of the present invention;

FIG. 2 is a timing diagram illustrating an exemplary embodiment of an operation of the low voltage DC-DC converting system of a vehicle according to the exemplary embodiment of the present invention illustrated in FIG. 1;

FIG. 3 is a diagram illustrating a method for predicting a charge time of an auxiliary battery depending on a propensity of a driver, used in a predicting unit of a low voltage DC-DC converter (LDC) according to the exemplary embodiment of the present invention illustrated in FIG. 1;

FIG. 4 is a flowchart illustrating a method for controlling an output of the low voltage DC-DC converter (LDC) of the vehicle according to an exemplary embodiment of the present invention.

FIG. 5 is a flowchart illustrating a process of creating a propensity distance of the driver illustrated in FIG. 4 according to the exemplary embodiment of the present invention;

FIG. 6 is a diagram illustrating a map table illustrated in FIG. 4 according to the exemplary embodiment of the present invention;

FIG. 7 is a graph illustrating an exemplary embodiment of output power of the low voltage DC-DC converter (LDC) of the vehicle according to the exemplary embodiment of the present invention illustrated in FIG. 1; and

FIG. 8 is a graph illustrating the exemplary embodiment of output power consumption of the low voltage DC-DC converter of the vehicle according to the exemplary embodiment of the present invention illustrated in FIG. 1.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

In order to sufficiently understand an object achieved by the present invention and exemplary embodiments of the present invention, the accompanying drawings illustrating the exemplary embodiments of the present invention and contents disclosed in the accompanying drawings should be referred to. Hereinafter, the present invention will be described in detail by describing exemplary embodiments of the present invention with reference to the accompanying drawings. In the description of the present invention, the detailed descriptions of known related constitutions or functions thereof may be omitted if they make the gist of the present invention unclear. Like reference numerals presented in respective drawings refer to like elements.

Throughout this specification and the claims that follow, when it is described that an element is “coupled” to another element, the element may be “directly coupled” to the other element or “electrically or mechanically coupled” to the other element through a third element. If it is not contrarily defined, all terms used herein including technological or scientific terms have the same meaning as those generally understood by a person with ordinary skill in the art. Terms which are defined in a generally used dictionary should be interpreted to have the same meaning as the meaning in the context of the related art, and are not to be interpreted with an ideally or excessively formal meaning unless clearly defined in the present specification.

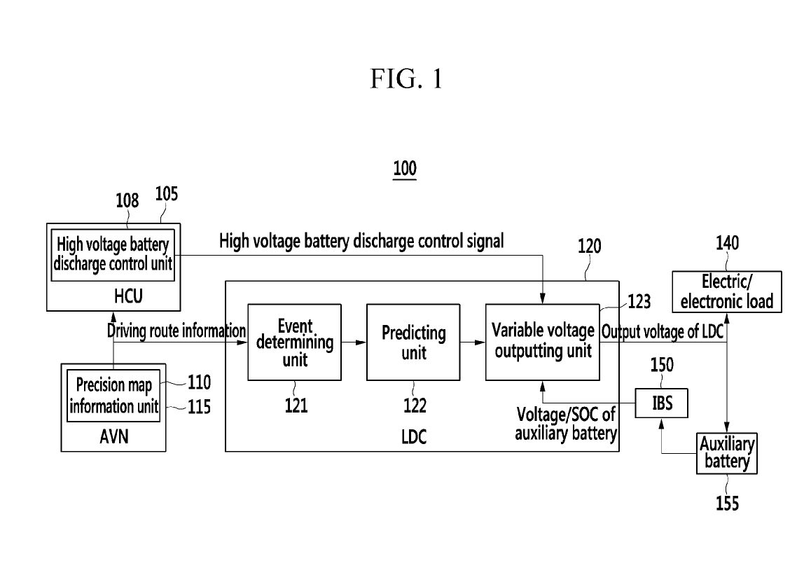

FIG. 1 is a block diagram illustrating a low voltage DC-DC converting system of a vehicle according to an exemplary embodiment of the present invention. Referring to FIG. 1, a low voltage DC-DC converting system 100 of an environmentally friendly vehicle may include a hybrid controller (HCU) 105, an audio video navigation (AVN) apparatus 115, a low voltage DC-DC converter (LDC) 120, an electric/electronic load 140, an intelligent battery sensor (IBS) 150, and an auxiliary battery 155. The vehicle may be a hybrid electric vehicle or an electric vehicle. The hybrid electric vehicle may use an engine and a motor as a power source, an engine clutch may be disposed between the motor and the engine (e.g., a diesel engine), and the hybrid electric vehicle may thus be actuated in an electric vehicle (EV) mode in which the hybrid electric vehicle is driven by the motor while the engine clutch is opened and in a hybrid electric vehicle (HEV) mode in which the hybrid electric vehicle may be driven by both the motor and the engine while the engine clutch is closed.

The exemplary embodiment of the present invention illustrated in FIG. 1 as control that varies output voltage of the LDC 120 based on a precision map (alternatively, precise road map information) may be configured to predict a charge time or a discharge time of the auxiliary battery 155 based on a propensity of a driver. In the exemplary embodiment, road information (e.g., road map information) including acceleration section information and deceleration section information in front of the vehicle may be calculated (extracted) using the AVN apparatus 115 and the IBS 150 mounted within the vehicle, and the output voltage of the LDC 120 may vary by predicting a charge change amount or a discharge change amount of the auxiliary battery 155 using the calculated road information (e.g., driving route information based on the road information).

Fuel efficiency of the vehicle may be improved through the variable control of the output voltage of the LDC, and charging or discharging of the auxiliary battery 155 may be optimized. In addition, the output voltage of the LDC may vary to maximize charging efficiency or discharging efficiency of the auxiliary battery 155 when an event occurs in the front of the vehicle (e.g., in an environment in a forward direction of the vehicle), which includes an acceleration section of the road and a deceleration section of the road by predicting a real-time vehicle driving state that corresponds to navigation information output from the AVN apparatus 115.

In particular, the HCU 105 as a controller that provides an instruction to operate the LDC 120 may include a high voltage battery discharge controller 108 configured to adjust power of a high voltage battery (e.g., main battery) mounted within the vehicle to be provided to the LDC 120. The HCU 105 may be configured to operate the components of the low voltage DC-DC converting system 100, which include the LDC 120, and the vehicle. The high voltage battery may be configured to output or discharge a high voltage of, for example, about 144 V or more, and may be an energy source that drives the motor and the LDC 120 of the vehicle.

The AVN apparatus 115 as an operator assistance system may include a precision map information unit 110 configured to provide driving route information (e.g., navigation information) including a distance to a destination, a speed of the vehicle, three dimensional (3D) road map information, and the like to the HCU 105 and the LDC 120, and may be a system acquired by integrating a multimedia apparatus and a navigation apparatus. The 3D road map information may include a gradient (e.g., a slope or an inclination) of the road and an altitude of the road. The AVN apparatus 115 as a vehicle terminal including at least one function of audio, video, navigation, digital multimedia broadcasting (DMB), and telematics may be mentioned as an audio visual system (AV system). The AVN system 115 may be configured to communicate with a traffic information center (not illustrated) via the telematics to collect traffic information based on a location and a driving direction of the vehicle, and may be configured to measure a speed of the vehicle.

The LDC 120 may be configured to provide the output voltage of the LDC to the electric/electronic load 140 and the auxiliary battery 155, and may include a transformer. The LDC 120 may further be configured to convert (e.g., output) the voltage of the high voltage main battery into a low voltage (e.g., about 12.5 V to 15.1 V) and provide electricity (e.g., power) to be suitable for a voltage used in the electric/electronic load 140 and the auxiliary battery 155. The LDC 120 may be configured to convert a high voltage DC voltage output from a high voltage battery (not illustrated) of the vehicle into a low voltage DC voltage to charge the auxiliary battery 155 and monitor an electric/electronic load amount of the vehicle. The LDC 120 may include an event determining unit 121, a predicting unit 122, and a variable voltage outputting unit 123, and may be configured to charge or discharge the auxiliary battery 155 that supplies power to the electric/electronic load 140 using the high voltage battery used for driving the vehicle.

The event determining unit 121 may be configured to predict a driving event (e.g., driving event information) of the vehicle based on the driving route information. The driving event information may include the acceleration section information of the vehicle, the deceleration section information of the vehicle, and fixed speed section information of the vehicle. The predicting unit 122 may be configured to predict a state of charge (SOC) of the auxiliary battery 155 in the driving event before a driving event (e.g., a front driving event of the vehicle) of a front section of the vehicle.

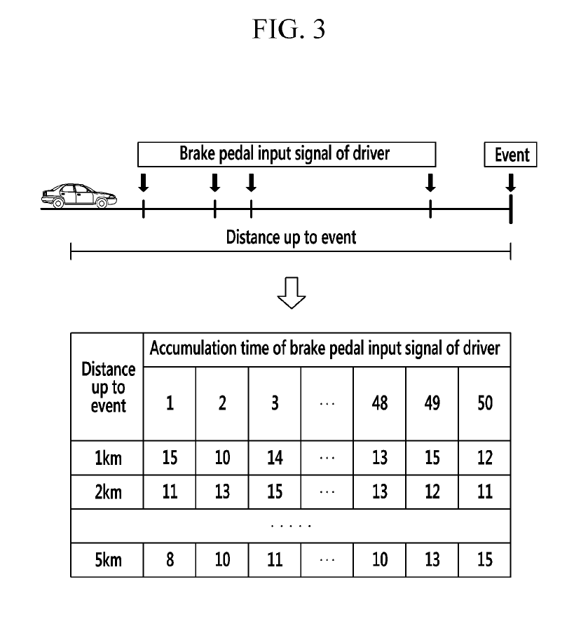

The predicted SOC of the auxiliary battery 155 may be determined by the charge time of the auxiliary battery based on a propensity at the time when a brake pedal is engaged (e.g., pressure is exerted onto the pedal) before the driving event of the front section of the vehicle, or determined by the discharge time of the auxiliary battery 155 based on a propensity at the time when an accelerator pedal is engaged (e.g., pressure is exerted onto the pedal) before the driving event of the front section of the vehicle, as illustrated in FIG. 3.

The charge time of the auxiliary battery 155 is a value that corresponds to a distance calculated using a brake signal indicating the amount of pressure exerted onto the brake pedal, and the discharge time of the auxiliary battery 155 may be a value that corresponds to a distance calculated using an acceleration signal indicating the amount of pressure exerted onto accelerator pedal. The brake signal and the acceleration signal may be provided by the HCU 105 or the LDC 120.

FIG. 3 is a diagram illustrating a method for predicting a charge time of an auxiliary battery based on a propensity of a driver (e.g., a tendency of accelerator or brake pedal engagement or engagement degree), which may be used in a predicting unit of a low voltage DC-DC converter (LDC) illustrated in FIG. 1. When a deceleration event or an acceleration event is detected in front of the vehicle as illustrated in FIG. 3, the time when the brake pedal is engaged and the time when the accelerator pedal is engaged may be different based on the propensity of the driver. Since the time of depressing the brake pedal and the time of depressing the accelerator pedal may be different, the fuel efficiency of the vehicle may vary through a vehicle test.

Referring to FIG. 3, when the charge time of the auxiliary battery 155 is predicted, the predicting unit 122 may use a brake pedal input signal (brake signal) indicating the amount of pressure exerted onto brake pedal (e.g., an engagement degree) and when the discharge time of the auxiliary battery 155 is predicted, the predicting unit 122 may use an accelerator pedal input signal (acceleration signal) indicating the amount of pressure exerted onto accelerator pedal (e.g., an engagement degree).

A distance up to the driving event such as the deceleration event or the acceleration event in front of the vehicle may be divided into driving cycles (DCs) (e.g., unit driving times) having the same time. The predicting unit 122 may be configured to store an accumulation time (e.g., about 13 seconds) of the brake signal in the respective DCs to calculate an average time for a total of 50 DCs. The predicting unit 122 may be configured to store an accumulation time (e.g., about 13 seconds) of the acceleration signal in the respective DCs to calculate the average time for the total of 50 DCs. The calculated value may be used to calculate the charge time or the discharge time of the auxiliary battery 155 to be reflected to precision map based LDC variable voltage control according to the exemplary embodiment of the present invention.

As described above, at the time of predicting a charge SOC change amount or a discharge SOC change amount of the auxiliary battery 155 based on the propensity of the driver, the charge time of the auxiliary battery 155 or the discharge time of the auxiliary battery 155 may be predicted by reflecting a deviation or offset between the time when the brake pedal is engaged and when the accelerator pedal is engaged based on the propensity of the driver. In other words, in the present invention, the charge time of the auxiliary battery 155 or the discharge time of the auxiliary battery 155 may be more accurately predicted by learning the time when pressure is exerted onto the brake pedal and the time when pressure is exerted onto the accelerator pedal based on the propensity of the driver.

Referring back to FIG. 1, the predicting unit 122 may be configured to calculate a predicted SOC of the auxiliary battery 155 based on a map table that includes the SOC of the auxiliary battery 155, which corresponds to the charge time or the discharge time of the auxiliary battery 155. The variable voltage outputting unit 123 may be configured to convert the output voltage of the LDC 120 and output the converted output voltage to the electric/electronic load 140 or the auxiliary battery 155 based on a comparison result of the current SOC of the auxiliary battery 155 and the predicted SOC of the auxiliary battery 155. The SOC of the auxiliary battery 155 (e.g., the voltage of the auxiliary battery 155) may be measured by the IBS 150.

When the current SOC of the auxiliary battery 155 is less than the predicted SOC of the auxiliary battery 155, the variable voltage outputting unit 123 may be configured to output a voltage to allow the voltage of the auxiliary battery 155 to be discharged, to the electric/electronic load 140. When the current SOC of the auxiliary battery 155 is greater than the predicted SOC of the auxiliary battery 155, the variable voltage outputting unit 123 may be configured to output a voltage to allow the auxiliary battery 155 to be charged. The variable voltage outputting unit 123 may further be configured to output a maximum value (e.g., about 15.1 V) of the output voltage of the LDC 120 to charge the auxiliary battery 155 in response to a high voltage battery discharge control signal output from the high voltage discharge controller 108. The high voltage battery discharge control signal may be a signal generated (output) when the SOC of the high voltage battery is at a high level.

The LDC 120 may further include a controller configured to operate the event determining unit 121, the predicting unit 122, and the variable voltage outputting unit 123. The controller may be, for example, one or more microprocessors or hardware including the microprocessors which operate by a program, and the program may include a series of commands for performing the aforementioned method for controlling the output of the low voltage DC-DC converter (LDC) included in the vehicle according to the exemplary embodiment of the present invention. The controller may be configured to receive an operating command regarding the LDC 120 from the HCU 105. The electric/electronic load 140 may include an air conditioner, a ventilating seat, a head lamp, an audio apparatus, a heater, or a wiper.

Further, the IBS 150 may be configured to sense the SOC of the auxiliary battery 155 and detect state information including the state of charge (SOC) or a state of health (SOH) of the auxiliary battery to stably supply current into the vehicle. The IBS 150 may further be configured to measure a voltage, a current, and a temperature of the auxiliary battery 155, and calculate the state of charge (SOC) and the state of health (SOH) based on the measured voltage, current, and temperature to detect the state information of the auxiliary battery 155 and may provide the state information to refer to the state information by various controllers in the vehicle. The auxiliary battery 155 as, for example, a 12 V battery may be a vehicle battery configured to start the vehicle or supply power to the electric/electronic load 140.

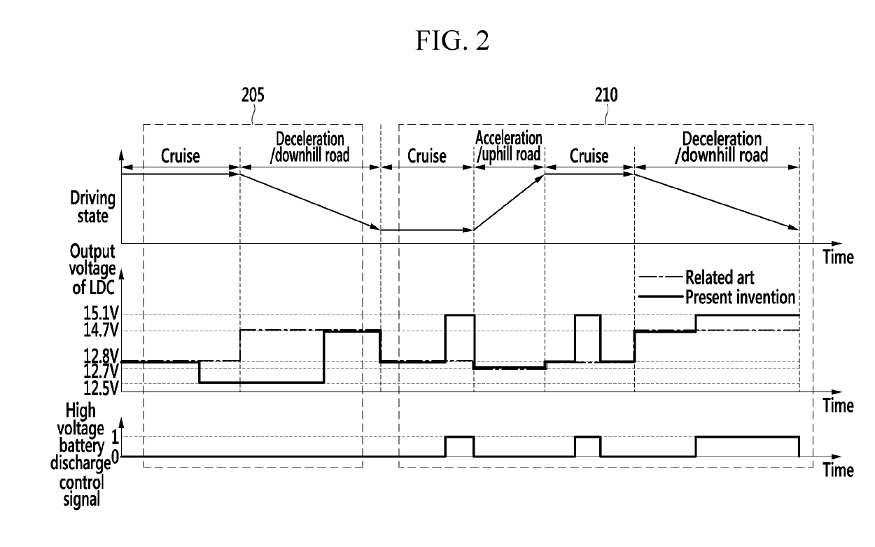

FIG. 2 is a timing diagram illustrating an exemplary embodiment of an operation of the low voltage DC-DC converting system of an environmentally friendly vehicle according to the exemplary embodiment of the present invention illustrated in FIG. 1. Referring to FIG. 2, in related art compared with the present invention, the output voltage of the LDC may vary as follows. In the deceleration section such as a downhill road or a curved road, the output voltage of the LDC may be adjusted to be increased to charge the auxiliary battery, and in an acceleration section such as an uphill road or a substantially straight road, the output voltage of the LDC may be adjusted to be decreased, and as a result, the power of the auxiliary battery may be used. In addition, in the cruise section, the output voltage of the LDC may be adjusted to be medium voltage, and as a result, the SOC of the auxiliary battery may be maintained.

In an example of a control logic for the output voltage of the low voltage DC-DC converter (LDC) as the related art, an command voltage for the LDC may be determined by considering a real-time driving mode (e.g., driving state) including a stop mode, an engine charge mode to charge the high voltage battery (e.g., main battery) using the engine, an electric vehicle mode (EV mode) which is a pure electric vehicle mode using power of the motor, and a regenerative braking mode to collect braking and inertia energy through generation of the motor when the vehicle is driven by braking or inertia and charge collected braking and inertia energy in the high voltage battery, and state of the auxiliary battery. In the example of the control logic, since the output voltage of the LDC varies based on the driving state, the charging efficiency or the discharging efficiency of the auxiliary battery is low and the energy may be lost. The energy loss may significantly influence the fuel efficiency of the vehicle, and the durability of the auxiliary battery may deteriorate by a rapid change of the voltage of the auxiliary battery.

The LDC 120 according to the exemplary embodiment of the present invention may operate in two modes based on an SOC charge or discharge strategy of the high voltage battery as illustrated in FIG. 2. Referring to FIGS. 1 and 2, in a first mode 210, at the time of determining a discharge control time of the high voltage battery (e.g., when the high voltage battery discharge control signal activated to a high level is received by the LDC 120), the auxiliary battery 155 may be charged by the output voltage (e.g., about 15.1 V) of the LDC regardless of the driving state of the vehicle. In the first mode 210, the variable voltage outputting unit 123 may be configured to change the output voltage of the LDC to a maximum value to charge the auxiliary battery 155.

In the related art, it may be difficult to consume the power as much as a desired SOC change amount at a desired time due to a characteristic of the high voltage battery when a driving mode of the vehicle, such as the cruise mode, the deceleration mode, or the acceleration mode is maintained. Accordingly, the output voltage of the LDC may be changed to the maximum value in the first mode 210, and as a result, the auxiliary battery 155 may be charged and power consumption of the electric/electronic load 140 may increase.

In a second mode 205, at the time when the LDC 120 does not receive the high voltage battery discharge control signal from the HCU 105, before the driving event (the deceleration event illustrated in FIG. 2) in front of the vehicle, the output voltage of the LDC may be adjusted to low voltage (e.g., about 12.5 V) by predicting the charge time of the auxiliary battery 155 based on the propensity of the driver, and as a result, the voltage of the auxiliary battery 155 may be discharged to the electric/electronic load 140 in the cruise event. When the driving event in front of the vehicle is the acceleration event, the output voltage of the LDC may be adjusted to high voltage (e.g., about 14.7 V) by predicting the discharge time of the auxiliary battery 155 based on the propensity of the driver.

In the second mode 205, at the time when the LDC 120 does not receive the high voltage battery discharge control signal from the HCU 105, the LDC 120 may be configured to predict the driving event information including the acceleration section and the deceleration section in front of the vehicle using the driving route information and predict the SOC charge amount or discharge amount of the auxiliary battery 155 in the driving event before the driving event in front of the vehicle based on the predicted event information and the charge time or discharge time of the auxiliary battery 155 based on the propensity of the driver.

When the SOC of the auxiliary battery 155 in the driving section before the event in front of the vehicle is less than the predicted SOC of the auxiliary battery 155, the output voltage of the LDC 120 may be changed to a voltage for discharging the auxiliary battery 155, and as a result, the power consumption of the LDC 120 may decrease and the durability of the auxiliary battery 155 may be improved. In the exemplary embodiment of the present invention, since a variable voltage which is the output voltage of the LDC may be changed in advance by predicting the charge change amount or the discharge change amount of the auxiliary battery through predicting a front road section of the vehicle, the durability of the auxiliary battery 155 may be improved.

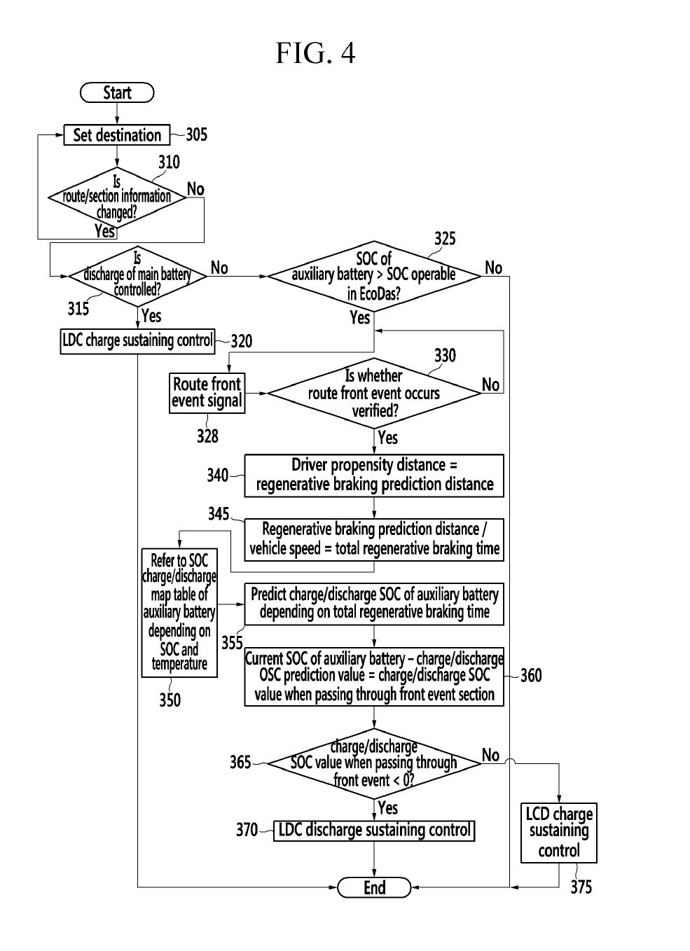

FIG. 4 is a flowchart illustrating a method for controlling an output of the low voltage DC-DC converter (LDC) of the vehicle according to an exemplary embodiment of the present invention. The method for controlling the output of the low voltage DC-DC converter (LDC) of the vehicle may be applied to the low voltage DC-DC converting system 100 of the vehicle illustrated in FIG. 1. Referring to FIGS. 1, 2, 3, and 4, the driver (user) may set a departure point and a destination using the AVN apparatus 115, and change a driving route from the departure point to the destination and section information included in the driving route (steps 305 and 310).

When the driving route is maintained, the high voltage battery discharge controller 108 of the HCU 105 may be configured to determine whether to discharge the main battery which is the high voltage battery (step 315). When the main battery is operated by the HCU 105, the LDC 120 may be configured to execute charge sustaining control to increase the output voltage of the LDC (320). In particular, the variable voltage outputting unit 120 of the LDC 120 may be configured to output the maximum value of the output voltage of the LDC 120 to charge the auxiliary battery 155 in response to the high voltage battery discharge control signal.

When the discharge of the main battery is not execute, the controller included in the LDC 120 may be configured to determine whether the SOC of the auxiliary battery 155 is greater than an SOC which may operate in an ECO driver assistance system (DAS) mode (e.g., an eco-mode) (step 325). The eco mode may be a mode to increase a drivable distance of the driver (vehicle) and decrease power consumption, and may be mode for performing the second mode. The SOC which may operate in the econ mode may be, for example, about 80%.

The event determining unit 121 may be configured to receive the driving route information which is a route front event signal (e.g., the driving event signal in front of the vehicle) from the AVN apparatus 115 when the SOC of the auxiliary battery 155 is greater than the SOC which may operate in the ECO DAS mode (328). In another exemplary embodiment of the present invention, step 325 may be omitted.

The event determining unit 121 may be configured to predict the driving event in front of the vehicle based on the driving route information (330). In particular, the event determining unit 121 may be configured to determine whether there is the driving event in front of the vehicle based on the driving route information. The driving route information may be provided by the AVN apparatus 115 including the 3D road map information. The driving event may include the acceleration section information of the vehicle, the deceleration section information of the vehicle, and the cruise section information of the vehicle.

When a driver propensity distance before the vehicle front event is a distance based on the brake signal, the predicting unit 122 may be configured to set the driver propensity distance as a regenerative braking prediction distance (340). The regenerative braking prediction distance may be a distance generated when the brake pedal is engaged in the driving event before the front event. When the brake pedal is engaged, the high voltage battery of the vehicle may be charged by regenerative braking. When the driver propensity distance before the front event is a distance based on the acceleration signal, the predicting unit 122 may be configured to set the driver propensity distance as a discharge prediction distance. The discharge prediction distance may be a distance generated when the accelerator pedal is engaged in the driving event before the front event.

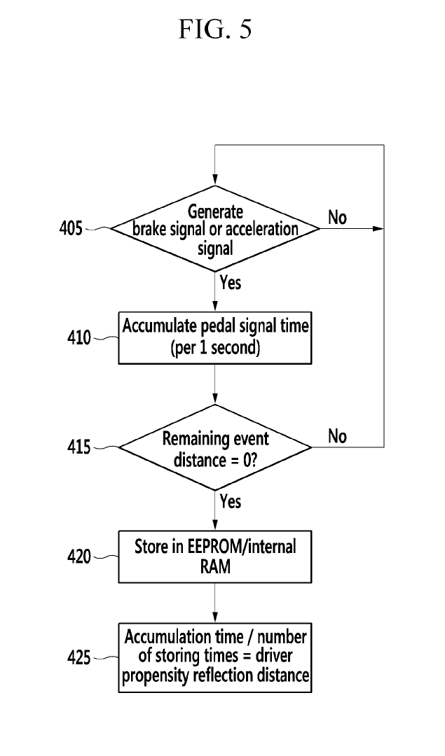

FIG. 5 is a flowchart illustrating a process of calculating a propensity distance of the driver illustrated in FIG. 4. Referring to FIG. 5, the predicting unit 122 may be configured to determine whether the brake signal or the accelerator signal is generated in the driving event before the front event (405).

Additionally, the predicting unit 122 may be configured to accumulate the brake signal or the acceleration signal which is the generated pedal signal until a residual event distance which remains up to the front event is 0 per one second (step 410 and 415). The predicting unit 122 may then be configured to store an accumulation time of the brake signal or the acceleration signal every driving cycle (e.g., unit driving time) and the number of times of the driving cycle (e.g., the number of storing times) in an electrically erasable and programmable read only memory (EEPROM) or a random-access memory (RAM) as a storage unit which may be included in the predicting unit 122.

The predicting unit 122 may be configured to set a value acquired by dividing the accumulation time by the number of storing times as a driver propensity reflection distance (e.g., driver propensity distance) (425). The maximum value of the number of storing times may be 50 driving cycles. The driver propensity distance illustrated in FIG. 5 may be learned or calculated by an experiment based on a method for calculating the driver propensity or the method for calculating the driver propensity distance when the vehicle including the low voltage converting system according to the exemplary embodiment of the present invention is actually driven.

Referring back to FIG. 4, the predicting unit 122 may be configured to set a value acquired by dividing the regenerative braking prediction distance by a vehicle speed as a total regenerative braking time (345). The predicting unit 122 may also be configured to set a value acquired by dividing the discharge prediction distance by the vehicle speed as the discharge time. The charge time of the auxiliary battery 155 may correspond to a distance calculated using a brake signal indicating the amount of pressure exerted onto brake pedal, and the discharge time of the auxiliary battery 155 may correspond to a distance calculated by using an acceleration signal indicating the amount of pressure exerted onto accelerator pedal. The predicting unit 122 may be configured to look up or refer to an SOC charge and discharge map table of the auxiliary battery based on the SOC and the temperature (e.g., the temperature of the auxiliary battery).

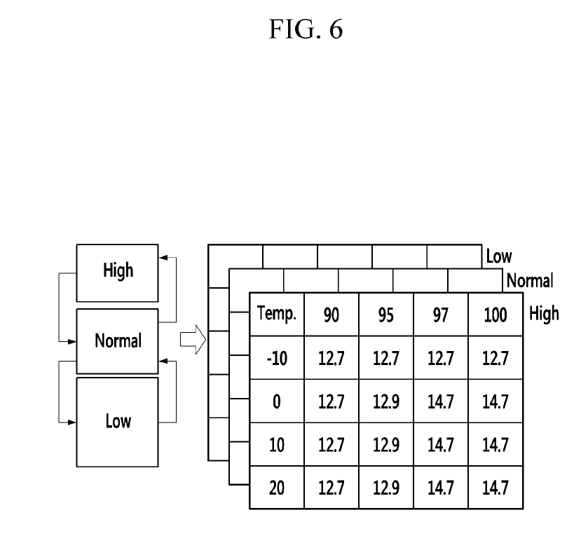

FIG. 6 is a diagram illustrating a map table illustrated in FIG. 4. The map table may include an SOC of the auxiliary battery based on the regenerative braking time that corresponds to the brake signal or the discharge time that corresponds to the acceleration signal. In regenerative braking, the LDC 120 may be configured to charge the auxiliary battery 155 using the charged high voltage battery. Referring back to FIG. 4, the predicting unit 122 may be configured to predict the SOC of the auxiliary battery 115 based on the regenerative braking time or the discharge time by referring to the map table (355).

In summary, the predicting unit 122 may be configured to predict the SOC of the auxiliary battery in the driving event before the driving event of the front section of the vehicle. The predicted SOC of the auxiliary battery 155 may be determined by the charge time of the auxiliary battery based on a propensity at the time when the vehicle brake pedal is engaged before the driving event of the front section of the vehicle or may be determined by the discharge time of the auxiliary battery 155 based on a propensity at the time when the vehicle accelerator pedal is engaged before the driving event of the front section of the vehicle. The predicting unit 122 may then be configured to calculate the predicted SOC of the auxiliary battery 155 based on the map table including the SOC of the auxiliary battery 155, which corresponds to the charge time or the discharge time of the auxiliary battery 155.

The variable voltage outputting unit 123 may be configured to set a value acquired by subtracting the predicted SOC from the current SOC of the auxiliary battery 155 as an SOC value of the auxiliary battery 155 when passing through the front event section (360). The current SOC of the auxiliary battery 155 may be measured by the intelligent battery sensor 150. The variable voltage outputting unit 123 may be configured to determine whether the SOC value is less than about 0 when passing through the front event (365).

When the SOC value is less than about 0 at the time of passing through the front event, the variable voltage outputting unit 123 may be configured to perform discharge sustaining control to output a voltage that allows the voltage of the auxiliary battery 155 to be discharged to the electric/electronic load 140 (370). When the SOC value is greater than 0 at the time of passing through the front event, the variable voltage outputting unit 123 may be configured to perform charge sustaining control to output a voltage that allows the voltage of the auxiliary battery 155 to be charged (375).

In particular, the variable voltage outputting unit 123 may be configured to convert the output voltage of the LDC 120 and output the converted output voltage to the electric/electronic load 140 or the auxiliary battery 155 based on a comparison result of the current SOC of the auxiliary battery 155 and the predicted SOC of the auxiliary battery 155. The discharge sustaining control, charge sustaining control, or constant voltage control by the LDC 120 may be determined based on the SOC of the auxiliary battery 155. When the state of the auxiliary battery 155 is the high level, the LDC 120 may be set in the discharge sustaining control. In the LDC discharge sustaining control, the range of the output voltage of the LDC may be set to, for example, about 12.5 to 12.8 volts.

When the state of the auxiliary battery 155 is the low level, the LDC 120 may be set in the charge sustaining control. In the LDC charge sustaining control, the range of the output voltage of the LDC may be set to, for example, about 14.5 to 15.1 V. When the state of the auxiliary battery 115 is a medium between the high level and the low level, the LDC 120 may be set in the constant voltage control. In the LDC constant voltage control, the range of the output voltage of the LDC may be set to, for example, about 12.8 to 14.5 V.

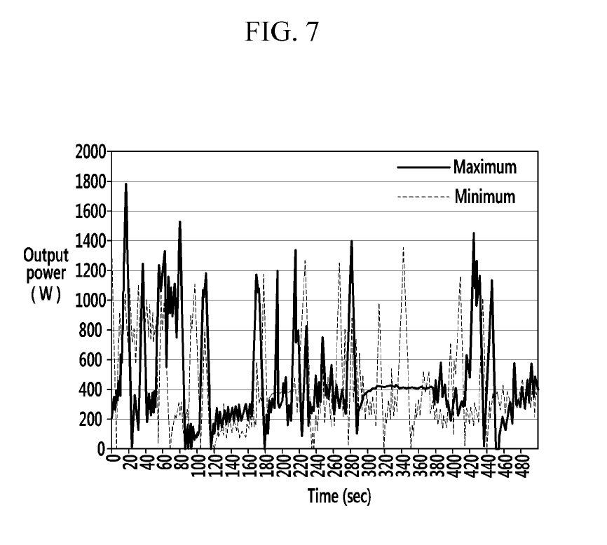

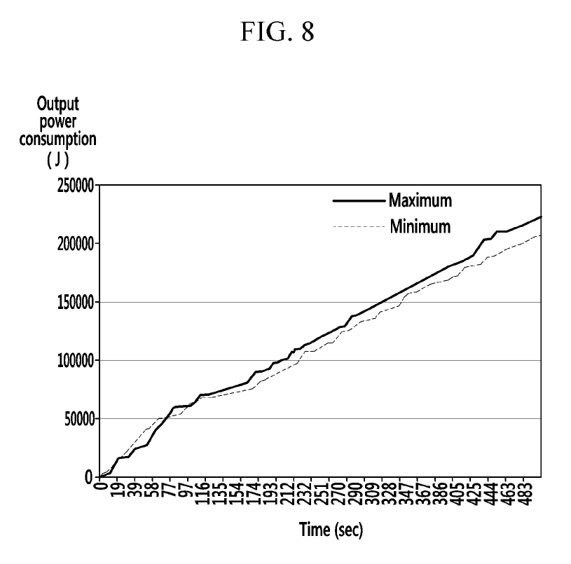

FIG. 7 is a graph illustrating an exemplary embodiment of output power of the low voltage DC-DC converter (LDC) of the vehicle according to the exemplary embodiment of the present invention illustrated in FIG. 1. FIG. 8 is a graph illustrating the exemplary embodiment of output power consumption (or electric energy output) of the low voltage DC-DC converter (LDC) of the vehicle according to the exemplary embodiment of the present invention illustrated in FIG. 1.

In FIG. 7, a solid line maximally expressed indicates the output power of the LDC of the related art when the exemplary embodiment of the present invention is not applied, and a dotted line minimally expressed may indicate the output power of the LDC when the exemplary embodiment of the present invention is applied. In FIG. 8, the solid line maximally expressed indicates the output power consumption of the LDC of the related art when the exemplary embodiment of the present invention is not applied, and the dotted line minimally expressed may indicate the output power consumption of the LDC when the exemplary embodiment of the present invention is applied.

Referring to FIGS. 7 and 8, it may be seen that maximum average LDC power consumption when the present invention is applied may be reduced by about 2.9%. Further, a change of the SOC of the auxiliary battery may be minimal when the present invention is applied and thus, the durability of the auxiliary battery may be prevented from deteriorating.

Components, “units”, blocks, or modules used in the exemplary embodiment may be implemented by software such as a task, a class, a sub-routine, a process, an object, an execution thread, and a program, or hardware such as a field programmable gate array (FPGA) or an application-specific integrated circuit (ASIC) performed at a predetermined area in a memory, and further, may be achieved by a combination of the software and the hardware. The components or “units” may be included in a computer-readable storing medium, or some of the components or “units” may be diffused and distributed in a plurality of computers.

As described above, the exemplary embodiments have been disclosed in the drawings and the specification. Herein, specific terms are used, but the specific terms are just used for describing the present invention and are not used to limit a meaning or limit the scope of the present invention disclosed in the claims. Therefore, it will be appreciated to those skilled in the art that various modifications may be made and equivalent embodiments are available based on the present invention. Accordingly, the true technical scope of the present invention should be defined by the technical spirit of the appended claims.

### DESCRIPTION OF SYMBOLS

105: Hybrid control unit (HCU)
115: Audio Video Navigation (AVN) apparatus
120: Low voltage DC-DC converter
140: Electric/electronic load
150: Intelligent battery sensor (IBS)
155: Auxiliary battery

What is claimed is:

1. A method for controlling an output of a low voltage direct current-direct current (DC-DC) converter (LDC) of a vehicle, the method comprising:
predicting, by a controller, a driving event of a front section of the vehicle based on driving route information, wherein the low voltage DC-DC converter is configured to charge or discharge an auxiliary battery supplying power to an electronic load using a high voltage battery for driving the vehicle;
predicting, by the controller, a state of charge (SOC) of the auxiliary battery in a driving event before the driving event of the front section of the vehicle; and
converting, by the controller, output voltage of the low voltage DC-DC converter and outputting the converted output voltage to the electronic load or the auxiliary battery based on a comparison result between a current SOC of the auxiliary battery and a predicted SOC of the auxiliary battery,
wherein the predicted SOC of the auxiliary battery is determined by a charge time of the auxiliary battery based on a propensity when a brake pedal is engaged before the driving event of the front section of the vehicle, or when an accelerator pedal is engaged before the driving event of the front section of the vehicle.

2. The method of claim 1, further comprising:
calculating, by the controller, the predicted SOC of the auxiliary battery based on a map table that includes the SOC of the auxiliary battery, which corresponds to the charge time or the discharge time of the auxiliary battery.

3. The method of claim 1, wherein the charge time of the auxiliary battery is a value that corresponds to a distance calculated using a brake signal indicating an engagement degree of the brake pedal, and the discharge time of the auxiliary battery is a value that corresponds to a distance calculated using an acceleration signal indicating an engagement degree of the accelerator pedal.

4. The method of claim 1, wherein the converting of the output voltage of the low voltage DC-DC converter and outputting the converted output voltage to the electronic load or the auxiliary battery includes:
outputting, by the controller, a voltage to allow the voltage of the auxiliary battery to be discharged to the electronic load when the current SOC of the auxiliary battery is less than the predicted SOC of the auxiliary battery.

5. The method of claim 1, wherein the converting of the output voltage of the low voltage DC-DC converter and outputting the converted output voltage to the electronic load or the auxiliary battery includes:
outputting, by the controller, a voltage that allows the auxiliary battery to be charged when the current SOC of the auxiliary battery is greater than the predicted SOC of the auxiliary battery.

6. The method of claim 1, further comprising:
outputting, by the controller, a maximum value of the output voltage of the low voltage DC-DC converter to charge the auxiliary battery in response to a high voltage battery discharge control signal.

7. The method of claim 1, wherein the driving event includes acceleration section information of the vehicle, deceleration section information of the vehicle, and cruise section information of the vehicle.

8. The method of claim 1, wherein the current SOC of the auxiliary battery is measured by an intelligent battery sensor.

9. The method of claim 1, wherein the driving route information is provided by an audio video navigation (AVN) apparatus including three-dimensional (3D) road map information.

10. A low voltage direct current-direct current (DC-DC) converter (LDC) of a vehicle, the LDC comprising:
a memory configured to store program instructions; and
a processor configured to execute the program instructions, the program instructions when executed configured to:
predict a driving event of the vehicle based on driving route information, wherein the low voltage DC-DC converter is configured to charge or discharge an auxiliary battery supplying power to an electronic load using a high voltage battery for driving the vehicle;
predict a state of charge (SOC) of the auxiliary battery in a driving event before the driving event of a front section of the vehicle; and
convert output voltage of the low voltage DC-DC converter and output the converted output voltage to the electronic load or the auxiliary battery based on a comparison result between a current SOC of the auxiliary battery and a predicted SOC of the auxiliary battery,
wherein the predicted SOC of the auxiliary battery is determined by a charge time of the auxiliary battery based on a propensity when a brake pedal is engaged before the driving event of the front section of the vehicle, or when an accelerator pedal is engaged before the driving event of the front section of the vehicle.

11. The LDC of claim 10, wherein the program instructions when executed are further configured to calculate the predicted SOC of the auxiliary battery based on a map table that includes the SOC of the auxiliary battery, which corresponds to the charge time or the discharge time of the auxiliary battery.

12. The LDC of claim 10, wherein the charge time of the auxiliary battery is a value that corresponds to a distance calculated using a brake signal indicating an engagement degree of the brake pedal and the discharge time of the auxiliary battery is a value that corresponds to a distance calculated using an acceleration signal indicating an engagement degree of the accelerator pedal.

13. The LDC of claim 10, wherein the program instructions when executed are further configured to output a voltage to allow the voltage of the auxiliary battery to be discharged to the electronic load when the current SOC of the auxiliary battery is less than the predicted SOC of the auxiliary battery.

14. The LDC of claim 10, wherein the program instructions when executed are further configured to output a voltage that allows the auxiliary battery to be charged when the current SOC of the auxiliary battery is greater than the predicted SOC of the auxiliary battery.

15. The LDC of claim 10, wherein the program instructions when executed are further configured to output a maximum value of the output voltage of the low voltage DC-DC converter to charge the auxiliary battery in response to a high voltage battery discharge control signal.

16. The LDC of claim 10, wherein the driving event includes acceleration section information of the vehicle, deceleration section information of the vehicle, and cruise section information of the vehicle.

17. The LDC of claim 10, wherein the current SOC of the auxiliary battery is measured by an intelligent battery sensor.

18. The LDC of claim 10, wherein the driving route information is provided by an audio video navigation (AVN) apparatus including three-dimensional (3D) road map information.
